(19) United States
(12) Patent Application Publication
(10) Pub. No.: US 2021/0201636 A1
(43) Pub. Date: Jul. 1, 2021

(54) APPARATUS AND METHOD FOR MONITORING AN ACCESS POINT

(71) Applicant: Essence Security International (E.S.I.) Ltd, Herzeliya Pituach (IL)

(72) Inventors: Ohad AMIR, Herzliya (IL); Jonathan SCHNAPP, Tel Aviv (IL)

(21) Appl. No.: 17/138,666

(22) Filed: Dec. 30, 2020

(30) Foreign Application Priority Data
Dec. 31, 2019 (GB) 1919447.1

(51) Int. Cl. G08B 13/00

(52) U.S. Cl. CPC G08B 13/00

(57) ABSTRACT

An apparatus for monitoring an access point of a premises is disclosed comprising processing circuitry 116 configured to receive indications of access point events and first-region events. The indications of access point events are obtained by processing output of an access point sensor 112 configured to detect a state of the access point. The indications of first-region events are obtained by processing output of an environment sensor 114 configured to detect motion and/or presence of a person within a field of view associated with the first region. The processing circuitry 116 is configured to determine a region from which the person caused an access point event based on whether the access point event occurred within a first time interval after a preceding first-region event, and wherein the first time interval is modifiable.

### CROSS-REFERENCE TO RELATED APPLICATIONS

The present application claims priority to United Kingdom Application No. 1919447.1 filed with the Intellectual Property Office of the United Kingdom on Dec. 31, 2019 which is incorporated herein by reference in its entirety for all purposes.

### TECHNICAL FIELD

The present invention relates to an apparatus and method for monitoring an access point of a premises, for example for premises security and/or for wellbeing or care of one or more people within the premises.

### BACKGROUND

A premises may have multiple openable and/or closable access points, for example doors and/or windows. An access point may comprise any point in the premises that may be used to access the premises, whether or not it is intended as a point of entry. For example, an openable window may not be intended to be used to enter to the premises, but may provide a potential access point to an intruder trying to enter the premises.

An access point may comprise two or more parts. The two or more parts may comprise, for example, a moveable part such as a door or window, and a fixed part such as the corresponding door or window frame. Alternatively, both parts may move, for example, two sliding or folding doors that meet to close an access point.

An access point sensor may be used to detect opening and/or closing of an access point. For example, the access point sensor may comprise a magnetic sensor. The magnetic sensor may be placed on a door or window, and a corresponding magnet may be placed on the door or window frame. Alternatively, the magnetic sensor may be placed on the frame and the magnet may be placed on the door or window. The magnetic sensor, in combination with the magnet, may be used to identify when the door or window is no longer in a closed state.

As an alternative to using a magnetic contact, other types of sensor may be used to sense a signal that is representative of opening or closing of a door or window. For example, electrical or optical contacts may be used. However, it has been found that magnetic contacts may be particularly well suited to such uses.

An intruder may seek to enter a premises by opening a door or window. Another potential way to enter the premises may involve the breaking of a window to either assist in the opening of the window or to allow the intruder to climb through the broken window. For example, the intruder may climb through the broken window if the window is not an openable window.

An access point sensor may alternatively or additionally comprise a shock sensor that is useable to detect a shock to the access point, for example, a shock to the door or window or to the door or window frame. The shock sensor may be used to detect the breaking of a window. The shock sensor may be used to detect activity that precedes an opening event, for example drilling through a door. The shock sensor may be based on, for example, an accelerometer, a piezoelectric sensor or another vibration sensor. The shock sensor may be placed in any suitable location on or near an access point. For example, a shock sensor may be placed on the openable part of the door or window, or on a frame against which the openable part is normally closed.

It has been found that systems having access point sensors may sometimes produce false alarms. For example, an access point sensor may be triggered by a door that is opened by an authorised user (for example, an inhabitant of the premises) rather by an intruder. The door may be opened while an alarm is armed or the door may be in an open state when the alarm is being armed. The open state of the door and/or the opening of the door may cause a false alarm to be issued.

It is an aim of the invention to at least ameliorate one or more of the above or other shortcomings of the prior art and/or to provide a useful alternative.

### SUMMARY

In a first aspect of the present invention, there is provided an apparatus for monitoring an access point of a premises. The access point separates a first region and a second region associated with the premises. The apparatus comprising processing circuitry configured to receive indications of access point events and first-region events. The indications of access point events are obtained by processing output of an access point sensor configured to detect a state of the access point.

The indications of first-region events are obtained by processing output of an environment sensor configured to detect motion and/or presence of a person within a field of view associated with the first region. The processing circuitry is further configured to determine a region from which the or a person caused an access point event, the region comprising one of the first region and the second region. The determining is based on whether the access point event occurred within a first time interval after a preceding first-region event. The first time interval is modifiable.

The first region may be located on an interior side of the access point. The second region may be located on an exterior side of the access point. The first-region events may comprise interior events.

The processing circuitry may be further configured to process instructions to modify the first time interval.

The processing circuitry may be further configured to determine a time difference between the access point event and the preceding first-region event. The instructions to modify the first time interval may be dependent on the determined time difference.

The instructions to modify the first time interval may be further dependent on at least one further time difference between a further first-region event and a further access point event.

The at least one further time difference may comprise a plurality of further time differences, each corresponding to a respective first-region event and respective access point event. The instructions to modify the first time interval may be dependent on a maximum time difference of the plurality of further time differences. The instructions to modify the first time interval may be dependent on a minimum time difference of the plurality of further time differences. The instructions to modify the first time interval may be dependent on an average time difference of the plurality of further time differences. The instructions to modify the first time interval may be dependent on a median time difference of the plurality of further time differences.

The plurality of further time differences may consist of a predetermined number of further time differences. The plurality of further time differences may consist of time differences occurring within a predetermined time period.

The processing circuitry may be further configured to determine a false alarm event. The processing circuitry may be further configured to modify the first time interval in response to the false alarm event.

The determining of the false alarm event may comprise determining that an access point event and a preceding first-region event have occurred with a time difference greater than the first time interval; processing instructions to issue an alarm in response to the time difference being greater than the first time interval; and receiving a notification that the alarm is a false alarm.

The processing circuitry may be configured to modify the first time interval in dependence on a time of day. The processing circuitry may be configured to modify the first time interval in dependence on an armed or unarmed mode. The processing circuitry may be configured to modify the first time interval in dependence on a location of the access point. The processing circuitry may be configured to modify the first time interval in dependence on a type of the access point. The processing circuitry may be configured to modify the first time interval in dependence on a characteristic of an occupant of the premises.

The modifying of the first time interval may comprise increasing the first time interval by a predetermined increment. The modifying of the first time interval may comprise decreasing the first time interval by a predetermined increment.

The modifying of the first time interval may be constrained by a maximum time interval. The modifying of the first time interval may be constrained by a minimum time interval.

The processing circuitry may be configured to process further instructions for a further modification to the first time interval only if a time greater than a predetermined delay window has elapsed since a most recent modification of the first time interval. The processing circuitry may be configured to process further instructions for a further modification to the first time interval only if a time greater than a predetermined delay window has elapsed since an event triggering a most recent modification of the first time interval.

The processing circuitry may be configured to determine that the access point event was caused from the first region if the access point event occurred within the first time interval after the preceding first-region event.

The apparatus may further comprise a transmitter. The processing circuitry may be further configured to instruct the transmitter to transmit a notification of a first type in response to the determining that the access point event was caused from the first region.

The processing circuitry may be configured to determine that the access point event was caused from the second region if the access point did not occur within the first time interval after the preceding first-region event.

The processing circuitry may be further configured to instruct the or a transmitter of the apparatus to transmit a notification of a second type in response to the determining that the access point event was caused from the second region.

The processing circuitry may be further configured to determine that a threat has occurred in response to the determining that the access point event was caused from the second region.

The processing circuitry may be further configured to instruct the or a transmitter of the apparatus to transmit a notification of a third type in response to each indication of a first-region event.

The processing circuitry is further configured to instruct the or a transmitter of the apparatus to transmit a notification of a fourth type in response to each indication of an access point event.

The processing circuitry may be configured to instruct an action in response to the determining of the region from which the access point event was caused.

The action may comprise an arming action. The action may comprise a disarming action. The action may comprise a triggering of an alarm. The action may comprise instructing a notification that an access point is open. The action may comprise instructing a notification that arming is not possible while the access point is open.

The detected state may comprise an open state of the access point. The processing circuitry may be further configured to instruct the action in dependence on the open state of the access point. The detected state may comprise a closed state of the access point. The processing circuitry may be further configured to instruct the action in dependence on the closed state of the access point.

The apparatus may have a first part and a second part. The or a transmitter of the apparatus may be configured to transmit signals from the first part of the apparatus to the second part of the apparatus. The transmitter may comprise a wireless transmitter.

The first part of the apparatus may comprise a sensor device mounted at the access point. The second part of the apparatus may comprise a control hub.

A first part of the processing circuitry may be located within the first part of the apparatus. A second part of the processing circuitry may be located within the second part of the apparatus.

The first part of the processing circuitry may be configured to determine the region from which the or a person caused an access point event. The first part of the processing circuitry may be configured to instruct the transmitter to transmit the notification of the first type to the second part of the apparatus. The first part of the processing circuitry may be configured to instruct the transmitter to transmit the notification of the second type to the second part of the apparatus. The first part of the processing circuitry may be configured to instruct the transmitter to transmit the notification of the third type to the second part of the apparatus. The first part of the processing circuitry may be configured to instruct the transmitter to transmit the notification of the fourth type to the second part of the apparatus.

The first part of the processing circuitry may be configured to determine a time difference between the access point event and the preceding first-region event. The first part of the processing circuitry may be configured to instruct the transmitter to transmit data comprising the time difference to the second part of the apparatus. The first part of the processing circuitry may be configured to transmit a notification of the third type with the data comprising the time difference. The first part of the processing circuitry may be configured to transmit a notification of the fourth type with the data comprising the time difference.

The second part of the processing circuitry may be configured to perform the determining of the region from which the person caused the access point event.

The first part of the processing circuitry may be configured to instruct the transmitter to transmit the data comprising the time difference only if a length of the time difference is within a predetermined window.

The first part of the processing circuitry may be configured to generate the indications of access point events and interior events. The first part of the processing circuitry may be configured to instruct the transmitter to transmit to the second part of the apparatus a first message comprising an indication of an environment event. The first part of the processing circuitry may be configured to instruct the transmitter to transmit to the second part of the apparatus a second message comprising an indication of an access point event. The second part of the processing circuitry may be configured to perform the receiving of the indications of access point events and interior events. The second part of the processing circuitry may be configured to perform the determining of the region from which the person caused an access point event.

The first message may comprise a first identifier associated with the environment sensor. The second message may comprise a second identifier associated with the access point sensor. The second identifier may be the same as the first identifier, such that there is a common identifier in the first message and the second message.

The second part of the processing circuitry may be configured to associate the first message and the second message in dependence on the common identifier.

A or the first part of the apparatus may comprise the access point sensor. The first part of the apparatus may have a surface for mounting the sensor device against a first part of the access point.

The sensor device may comprise the access point sensor. The sensor device may have a surface for mounting the sensor device against a first part of the access point. At least some of the indications of access point events may be based on a separation between the access point sensor and a component that is mounted on a second part of the access point. The first part of the access point and the second part of the access point may be relatively moveable. The apparatus may further comprise a further part comprising the component.

A or the first part of the apparatus may comprise the environment sensor. The surface may be located on an opposite side of the first part of the apparatus to a lens of the environment sensor.

The sensor device may comprise the environment sensor. The surface may be located on an opposite side of the sensor device to a lens of the environment sensor.

The sensor device may have a width parallel to a plane in which the access point lies. The access point sensor may be at a location that is at a middle of the width of the sensor device. The environment sensor may be at a location that is at a middle of the width of the sensor device.

The access point sensor, the environment sensor and the transmitter may be housed in a common housing.

The state of the access point may comprise an open state of the access point. The state of the access point may comprise a closed state of the access point. The state of the access point may comprise a vibrational state of at least part of the access point. The detecting of the state of the access point may comprise detecting a parameter that changes with movement of at least one part of the access point.

The parameter may be magnetic field. The access point sensor may comprise a magnetic field sensor mounted on a or the first part of the access point. The magnetic field sensor may be configured to sense a magnetic field of a or the component mounted on a or the second part of the access point.

The access point sensor may comprise a contact sensor. The contact sensor may comprise a magnetic sensor configured to sense magnetic contact with a magnetic element. The access point sensor may comprise an optical sensor. The access point sensor may comprise an electrical sensor. The access point sensor may comprise a shock sensor. The access point sensor may comprise a vibration sensor. The access point sensor may comprise an accelerometer.

The environment sensor may comprise a passive infrared sensor.

The access point may comprise a door. The access point may comprise a window. The access point may comprise a gate.

In a second aspect of the invention, which may be provided independently, there is provided a method for monitoring an access point of a premises. The access point separates a first region and a second region associated with the premises. The method comprises receiving indications of access point events and first-region events, wherein the indications of access point events are obtained by processing output of an access point sensor configured to detect a state of the access point, and the indications of first-region events are obtained by processing output of an environment sensor configured to detect motion and/or presence of a person within a field of view associated with the first region; and determining a region from which the or a person caused an access point event. The region comprises one of the first region and the second region. The determining is based on whether the access point event occurred within a first time interval after a preceding first-region event. The first time interval is modifiable.

In a third aspect of the invention, which may be provided independently, there is provided a memory comprising instructions which, when executed by processing circuitry, cause the processing circuitry to perform the steps of: receiving indications of access point events and first-region events, wherein the indications of access point events are obtained by processing output of an access point sensor configured to detect a state of an access point of a premises, the access point separating a first region and a second region associated with the premises, and the indications of first-region events are obtained by processing output of an environment sensor configured to detect motion and/or presence of a person within a field of view associated with the first region; and determining a region from which the or a person caused an access point event. The region comprises one of the first region and the second region. The determining is based on whether the access point event occurred within a first time interval after a preceding first-region event. The first time interval is modifiable.

In a fourth aspect of the invention, which may be provided independently, there is provided an apparatus for monitoring an access point of a premises. The access point separates a first region and a second region associated with the premises. The apparatus comprises a first part of the apparatus comprising first processing circuitry configured to receive indications of access point events and interior events, wherein the indications of access point events are obtained by processing output of an access point sensor configured to detect a state of the access point; and the indications of first-region events are obtained by processing output of an environment sensor configured to detect motion and/or presence of a person within a field of view associated with the first region. The first processing circuitry is further configured to determine a region from which the or a person caused an access point event. The region comprises one of the first region and the second region. The determining is based on whether the access point event occurred within a first time interval after a preceding first-region event. If it is determined that the access point event was caused from the first region, the first processing circuitry is further configured to instruct a transmitter of the first part of the apparatus to transmit a notification of a first type. The apparatus further comprises a second part of the apparatus comprising second processing circuitry configured to receive and process the notification of the first type.

The first part of the apparatus may comprise a sensor device. The sensor device may be mounted at the access point. The second part of the apparatus may comprise a control hub.

The first processing circuitry may be configured to determine that the access point event was caused from the first region if the access point event occurred within the first time interval after the preceding first-region event.

The first processing circuitry may be configured to determine that the access point event was caused from the second region if the access point did not occur within the first time interval after the preceding first-region event.

The first processing circuitry may be further configured to instruct the transmitter to transmit a notification of a second type in response to the determining that the access point event was caused from the second region.

The first processing circuitry may be further configured to determine that a threat has occurred in response to the determining that the access point event was caused from the second region. The second processing circuitry may be further configured to determine that a threat has occurred in response to receiving the notification of the second type.

The first processing circuitry may be further configured to instruct the transmitter to transmit a notification of a third type in response to each indication of a first-region event. The first processing circuitry may be further configured to instruct the transmitter to transmit a notification of a fourth type in response to each indication of an access point event.

The first processing circuitry may be configured to instruct an action in response to the determining of the region from which the access point event was caused. The second processing circuitry may be configured to instruct an action in response to receiving the notification of the first type. The second processing circuitry may be configured to instruct an action in response to receiving the notification of the second type. The second processing circuitry may be configured to instruct an action in response to receiving the notification of the third type. The second processing circuitry may be configured to instruct an action in response to receiving the notification of the fourth type.

The action may comprise an arming action. The action may comprise a disarming action. The action may comprise a triggering of an alarm. The action may comprise instructing a notification that an access point is open. The action may comprise instructing a notification that arming is not possible while the access point is open.

The detected state may comprise an open state of the access point. The first processing circuitry may be further configured to instruct the action in dependence on the open state of the access point. The second processing circuitry may be further configured to instruct the action in dependence on the open state of the access point. The detected state may comprise a closed state of the access point. The first processing circuitry may be further configured to instruct the action in dependence on the closed state of the access point. The second processing circuitry may be further configured to instruct the action in dependence on the closed state of the access point.

The transmitter may comprise a wireless transmitter.

The first part of the apparatus may comprise the access point sensor. The first part of the apparatus may have a surface for mounting the first part of the apparatus against a first part of the access point. At least some of the indications of access point events may be based on a separation between the access point sensor and a component that is mounted on a second part of the access point. The first part of the access point and the second part of the access point may be relatively moveable. The apparatus may further comprising a further part comprising the component.

The first part of the apparatus may comprise the environment sensor. The surface may be located on an opposite side of the sensor device to a lens of the environment sensor.

The first part of the apparatus may have a width parallel to a plane in which the access point lies. The access point sensor and/or the environment sensor may be at a location that is at a middle of the width of the first part of the apparatus.

The state of the access point may comprise an open or closed state of the access point. The state of the access point may comprise a vibrational state of at least part of the access point. The detecting of the state of the access point may comprise detecting a parameter that changes with movement of at least one part of the access point. The parameter may be magnetic field. The access point sensor may comprise a magnetic field sensor mounted on a or the first part of the access point. The magnetic field sensor may be configured to sense a magnetic field of a or the component mounted on a or the second part of the access point.

The access point sensor may comprise at least one of a contact sensor, an optical sensor, an electrical sensor, a shock sensor, a vibration sensor, an accelerometer. The environment sensor may comprise a passive infrared sensor.

The access point may comprise at least one of a door, a window, a gate.

In a fifth aspect of the invention, which may be provided independently, there is provided a sensor device for monitoring an access point of a premises. The access point separates a first region and a second region associated with the premises. The sensor device comprises first processing circuitry configured to receive indications of access point events and interior events, wherein the indications of access point events are obtained by processing output of an access point sensor configured to detect a state of the access point; and the indications of first-region events are obtained by processing output of an environment sensor configured to detect motion and/or presence of a person within a field of view associated with the first region. The first processing circuitry is further configured to determine a region from which the or a person caused an access point event. The region comprises one of the first region and the second region. The determining is based on whether the access point event occurred within a first time interval after a preceding first-region event. If it is determined that the access point event was caused from the first region, the first processing circuitry is further configured to instruct a transmitter of the first part of the apparatus to transmit a notification of a first type.

In a sixth aspect of the invention, which may be provided independently, there is provided a method for monitoring an access point of a premises. The access point separates a first region and a second region associated with the premises. The method comprises: receiving, by first processing circuitry of a first part of an apparatus, indications of access point events and interior events, wherein the indications of access point events are obtained by processing output of an access point sensor configured to detect a state of the access point, and the indications of first-region events are obtained by processing output of an environment sensor configured to detect motion and/or presence of a person within a field of view associated with the first region. The method further comprises determining, by the first processing circuitry, a region from which the or a person caused an access point event. The region comprises one of the first region and the second region. The determining is based on whether the access point event occurred within a first time interval after a preceding first-region event. The method further comprises, if it is determined that the access point event was caused from the first region, instructing by the first processing circuity a transmitter to transmit a notification of a first type.

The method may further comprise receiving, by second processing circuitry of a second part of the apparatus, the notification of the first type, and processing, by the second processing circuitry, the notification of the first type.

In a seventh aspect of the invention, which may be provided independently, there is provided a memory comprising instructions which, when executed by processing circuitry, cause the processing circuitry to perform the steps of: receiving indications of access point events and first-region events, wherein the indications of access point events are obtained by processing output of an access point sensor configured to detect a state of an access point of a premises, the access point separating a first region and a second region associated with the premises, and the indications of first-region events are obtained by processing output of an environment sensor configured to detect motion and/or presence of a person within a field of view associated with the first region; determining a region from which the or a person caused an access point event, the region comprising one of the first region and the second region, wherein the determining is based on whether the access point event occurred within a first time interval after a preceding first-region event; and, if it is determined that the access point event was caused from the first region, instructing a transmitter to transmit a notification of a first type.

In an eighth aspect of the invention, which may be provided independently, there is provided an apparatus for monitoring an access point of a premises. The access point separates a first region and a second region associated with the premises. The apparatus comprises a first part of the apparatus comprising first processing circuitry configured to receive indications of access point events and interior events, wherein the indications of access point events are obtained by processing output of an access point sensor configured to detect a state of the access point; and the indications of first-region events are obtained by processing output of an environment sensor configured to detect motion and/or presence of a person within a field of view associated with the first region. The first processing circuitry is further configured to determine a time difference between an access point event and a preceding first-region event and to instruct a transmitter to transmit data comprising the time difference to a second part of the apparatus. The apparatus further comprises a second part of the apparatus comprising second processing circuitry configured to: use the time difference to determine whether the access point event occurred within a first time interval after the preceding first-region event; and determine a region from which the or a person caused an access point event, the region comprising one of the first region and the second region, wherein the determining is based on whether the access point event occurred within the first time interval after a preceding first-region event.

The first part of the apparatus may comprise a sensor device. The sensor device may be mounted at the access point. The second part of the apparatus may comprise a control hub.

The second processing circuitry may be configured to determine that the access point event was caused from the first region if the access point event occurred within the first time interval after the preceding first-region event.

The second processing circuitry may be configured to determine that the access point event was caused from the second region if the access point did not occur within the first time interval after the preceding first-region event.

The second processing circuitry may be further configured to determine that a threat has occurred in response to the determining that the access point event was caused from the second region.

The second processing circuitry may be configured to instruct an action in response to the determining of the region from which the access point event was caused.

The action may comprise an arming action. The action may comprise a disarming action. The action may comprise a triggering of an alarm. The action may comprise instructing a notification that an access point is open. The action may comprise instructing a notification that arming is not possible while the access point is open.

The detected state may comprise an open state of the access point. The second processing circuitry may be further configured to instruct the action in dependence on the open state of the access point. The detected state may comprise a closed state of the access point. The second processing circuitry may be further configured to instruct the action in dependence on the closed state of the access point.

The transmitter may comprise a wireless transmitter.

The first processing circuitry may be configured to instruct the transmitter to transmit the data comprising the time difference only if a length of the time difference is within a predetermined window.

The first part of the apparatus may comprise the access point sensor. The first part of the apparatus may have a surface for mounting the first part of the apparatus against a first part of the access point. At least some of the indications of access point events may be based on a separation between the access point sensor and a component that is mounted on a second part of the access point. The first part of the access point and the second part of the access point may be relatively moveable. The apparatus may further comprising a further part comprising the component.

The first part of the apparatus may comprise the environment sensor. The surface may be located on an opposite side of the sensor device to a lens of the environment sensor.

The first part of the apparatus may have a width parallel to a plane in which the access point lies. The access point sensor and/or the environment sensor may be at a location that is at a middle of the width of the first part of the apparatus.

The state of the access point may comprise an open or closed state of the access point. The state of the access point may comprise a vibrational state of at least part of the access point. The detecting of the state of the access point may comprise detecting a parameter that changes with movement of at least one part of the access point. The parameter may be magnetic field. The access point sensor may comprise a magnetic field sensor mounted on a or the first part of the access point. The magnetic field sensor may be configured to sense a magnetic field of a or the component mounted on a or the second part of the access point.

The access point sensor may comprise at least one of a contact sensor, an optical sensor, an electrical sensor, a shock sensor, a vibration sensor, an accelerometer. The environment sensor may comprise a passive infrared sensor.

The access point may comprise at least one of a door, a window, a gate.

In an ninth aspect of the invention, which may be provided independently, there is provided a method for monitoring an access point of a premises. The access point separates a first region and a second region associated with the premises. The method comprises receiving, by first processing circuitry of a first part of an apparatus, indications of access point events and interior events, wherein the indications of access point events are obtained by processing output of an access point sensor configured to detect a state of the access point, and the indications of first-region events are obtained by processing output of an environment sensor configured to detect motion and/or presence of a person within a field of view associated with the first region. The method further comprises determining, by the first processing circuitry, a time difference between an access point event and a preceding first-region event and instructing, by the first processing circuitry, a transmitter to transmit data comprising the time difference to a second part of the apparatus. The method may further comprise using, by second processing circuitry of the second part of the apparatus, the time difference to determine whether the access point event occurred within a first time interval after the preceding first-region event; and determining, by the second processing circuitry a region from which the or a person caused an access point event, the region comprising one of the first region and the second region, wherein the determining is based on whether the access point event occurred within the first time interval after a preceding first-region event.

In a tenth aspect of the invention, which may be provided independently, there is provided a memory comprising instructions which, when executed by processing circuitry, cause the processing circuitry to perform the steps of: receiving indications of access point events and first-region events, wherein the indications of access point events are obtained by processing output of an access point sensor configured to detect a state of an access point of a premises, the access point separating a first region and a second region associated with the premises, and the indications of first-region events are obtained by processing output of an environment sensor configured to detect motion and/or presence of a person within a field of view associated with the first region; determining a time difference between an access point event and a preceding first-region event and instructing a transmitter to transmit data comprising the time difference.

In an eleventh aspect of the invention, which may be provided independently, there is provided a memory comprising instructions which, when executed by processing circuitry, cause the processing circuitry to perform the steps of: receiving a time difference between an access point event and a preceding first-region event; using the time difference to determine whether the access point event occurred within a first time interval after the preceding first-region event; and determining a region from which the or a person caused an access point event, the region comprising one of the first region and the second region, wherein the determining is based on whether the access point event occurred within the first time interval after a preceding first-region event.

In a twelfth aspect of the invention, which may be provided independently, there is provided an apparatus for monitoring an access point of a premises. The access point separates a first region and a second region associated with the premises. The apparatus comprises a first part of the apparatus comprising first processing circuitry configured to: generate indications of access point events by processing output of an access point sensor configured to detect a state of the access point; generate indications of first-region events are obtained by processing output of a environment sensor configured to detect motion and/or presence of a person within a field of view associated with the first region; instruct a transmitter to transmit to a second part of the apparatus a first message comprising an indication of a first-region event and a first identifier associated with the environment sensor; and instruct the transmitter to transmit to the second part of the apparatus a second message comprising an indication of an access point event and a second identifier associated with the access point sensor, wherein the second identifier is the same as the first identifier, such that there is a common identifier in the first message and the second message. The apparatus further comprises a second part of the apparatus comprising second processing circuitry configured to: receive the first message and the second message; associate the first message and the second message in dependence on the common identifier; and
determine a region from which the or a person caused the access point event based on a timing relationship between the first-region event and the access point event, the region comprising one of the first region and the second region.

The determining of the region from which the person caused the access point event may be based on whether the access point event occurred within a first time interval after the first-region event.

The first part of the apparatus may comprise a sensor device. The sensor device may be mounted at the access point. The second part of the apparatus may comprise a control hub. The first part of the apparatus may comprise the environment sensor and the access point sensor. The sensor device may comprise the environment sensor and the access point sensor.

The second processing circuitry may be configured to determine that the access point event was caused from the first region if the access point event occurred within the first time interval after the preceding first-region event. The second processing circuitry may be configured to determine that the access point event was caused from the second region if the access point did not occur within the first time interval after the preceding first-region event. The second processing circuitry may be further configured to determine that a threat has occurred in response to the determining that the access point event was caused from the second region.

The second processing circuitry may be configured to instruct an action in response to the determining of the region from which the access point event was caused. The action may comprise an arming action. The action may comprise a disarming action. The action may comprise a triggering of an alarm. The action may comprise instructing a notification that an access point is open. The action may comprise instructing a notification that arming is not possible while the access point is open.

The detected state may comprise an open state of the access point. The second processing circuitry may be further configured to instruct the action in dependence on the open state of the access point. The detected state may comprise a closed state of the access point. The second processing circuitry may be further configured to instruct the action in dependence on the closed state of the access point.

The transmitter may comprise a wireless transmitter.

The first part of the apparatus may comprise the access point sensor. The first part of the apparatus may have a surface for mounting the first part of the apparatus against a first part of the access point. At least some of the indications of access point events may be based on a separation between the access point sensor and a component that is mounted on a second part of the access point. The first part of the access point and the second part of the access point may be relatively moveable. The apparatus may further comprising a further part comprising the component.

The first part of the apparatus may comprise the environment sensor. The surface may be located on an opposite side of the sensor device to a lens of the environment sensor.

The first part of the apparatus may have a width parallel to a plane in which the access point lies, and the access point sensor and/or the environment sensor may be at a location that is at a middle of the width of the first part of the apparatus.

The state of the access point may comprise an open or closed state of the access point. The state of the access point may comprise a vibrational state of at least part of the access point. The detecting of the state of the access point may comprise detecting a parameter that changes with movement of at least one part of the access point. The parameter may be magnetic field. The access point sensor may comprise a magnetic field sensor mounted on a or the first part of the access point. The magnetic field sensor may be configured to sense a magnetic field of a or the component mounted on a or the second part of the access point.

The access point sensor may comprise at least one of a contact sensor, an optical sensor, an electrical sensor, a shock sensor, a vibration sensor, an accelerometer. The environment sensor may comprise a passive infrared sensor. The access point may comprise at least one of a door, a window, a gate.

In a thirteenth aspect of the invention, which may be provided independently, there is provided a method for monitoring an access point of a premises. The access point separates a first region and a second region associated with the premises. The method comprises generating, by first processing circuitry of a first part of an apparatus, indications of access point events by processing output of an access point sensor configured to detect a state of the access point; generating, by the first processing circuitry, indications of first-region events are obtained by processing output of a environment sensor configured to detect motion and/or presence of a person within a field of view associated with the first region; instructing, by the first processing circuitry, a transmitter to transmit to a second part of the apparatus a first message comprising an indication of a first-region event and a first identifier associated with the environment sensor; and instructing, by the first processing circuitry, the transmitter to transmit to the second part of the apparatus a second message comprising an indication of an access point event and a second identifier associated with the access point sensor, wherein the second identifier is the same as the first identifier, such that there is a common identifier in the first message and the second message. The method further comprises: receiving, by second processing circuitry of a second part of the apparatus, the first message and the second message; associating, by the second processing circuitry, the first message and the second message in dependence on the common identifier; and determining, by the second processing circuitry a region from which the or a person caused the access point event based on a timing relationship between the first-region event and the access point event, the region comprising one of the first region and the second region.

In a fourteenth aspect of the invention, which may be provided independently, there is provided a control hub for monitoring a premises, the control hub comprising processing circuitry configured to receive messages from a plurality of peripheral devices comprising a plurality of sensors. Each sensor is associated with an identifier, and at least one identifier is common to at least two of the sensors. The messages comprise a first message comprising an indication of a first-region event, the indication of the first-region event having been obtained by processing an output of an environment sensor configured to configured to detect motion and/or presence of a person within a field of view associated with an access point, wherein the first message comprises a first identifier associated with the respective environment sensor; and a second message comprising an indication of an access point event, the indication of the access point event having been obtained by processing an output of an access point sensor at the access point, wherein the access point sensor is configured to detect a state of the access point, and wherein the second message comprises a second identifier associated with the respective access point sensor. The processing circuitry is configured to determine that the second identifier is the same as the first identifier, such that there is a common identifier in the first message and the second message; associate the first message and the second message in dependence on the common identifier; and identify an event at the access point based on a timing relationship between the first-region event of the first message and the access point event of the associated second message.

In a fifteenth aspect of the invention, which may be provided independently, there is provided a method for monitoring a premises, the method comprising: receiving by processing circuitry of a control hub messages from a plurality of peripheral devices comprising a plurality of sensors, wherein each sensor is associated with an identifier, and at least one identifier is common to at least two of the sensors. The messages comprise a first message comprising an indication of a first-region event, the indication of the first-region event having been obtained by processing an output of an environment sensor configured to configured to detect motion and/or presence of a person within a field of view associated with an access point, wherein the first message comprises a first identifier associated with the respective environment sensor; and a second message comprising an indication of an access point event, the indication of the access point event having been obtained by processing an output of an access point sensor at the access point, wherein the access point sensor is configured to detect a state of the access point, and wherein the second message comprises a second identifier associated with the respective access point sensor. The method further comprises determining, by the processing circuitry, that the second identifier is the same as the first identifier, such that there is a common identifier in the first message and the second message; associating, by the processing circuitry, the first message and the second message in dependence on the common identifier; and identifying, by the processing circuitry, an event at the access point based on a timing relationship between the first-region event of the first message and the access point event of the associated second message.

In a sixteenth aspect of the invention, which may be provided independently, there is provided a memory comprising instructions which, when executed by processing circuitry, cause the processing circuitry to perform the steps of: receiving messages from a plurality of peripheral devices comprising a plurality of sensors, wherein each sensor is associated with an identifier, and at least one identifier is common to at least two of the sensors; the messages comprising a first message comprising an indication of a first-region event, the indication of the first-region event having been obtained by processing an output of an environment sensor configured to configured to detect motion and/or presence of a person within a field of view associated with an access point, wherein the first message comprises a first identifier associated with the respective environment sensor; and a second message comprising an indication of an access point event, the indication of the access point event having been obtained by processing an output of an access point sensor at the access point, wherein the access point sensor is configured to detect a state of the access point, and wherein the second message comprises a second identifier associated with the respective access point sensor; determining that the second identifier is the same as the first identifier, such that there is a common identifier in the first message and the second message; associating the first message and the second message in dependence on the common identifier; and identifying an event at the access point based on a timing relationship between the first-region event of the first message and the access point event of the associated second message.

Features in one aspect may be applied as features in any other aspect, in any appropriate combination. For example, method features may be provided as apparatus features or vice versa. Features of an apparatus of one aspect may be provided as features of an apparatus of another aspect. Features of a method of one aspect may be provided as features of a method of another aspect.

### BRIEF DESCRIPTION OF THE DRAWINGS

Embodiments will now be described by way of example only, and with reference to the accompanying drawings, of which:

FIG. 1 is a schematic illustration of a system for monitoring an access point of a premises in accordance with an embodiment;

FIG. 2 is an alternative view of the system of FIG. 1, showing a field of view of an environment sensor;

FIG. 3 is a flow chart illustrating in overview a method of a first embodiment;

FIG. 4 is a flow chart illustrating in overview a method of the first embodiment in greater detail;

FIG. 5 is a flow chart illustrating in overview a method of a second embodiment; and

FIG. 6 is a flow chart illustrating in overview a method of a third embodiment.

As used herein, except where the context requires otherwise, the terms “comprises”, “includes”, “has”, and grammatical variants of these terms, are not intended to be exhaustive. They are intended to allow for the possibility of further additives, components, integers or steps.

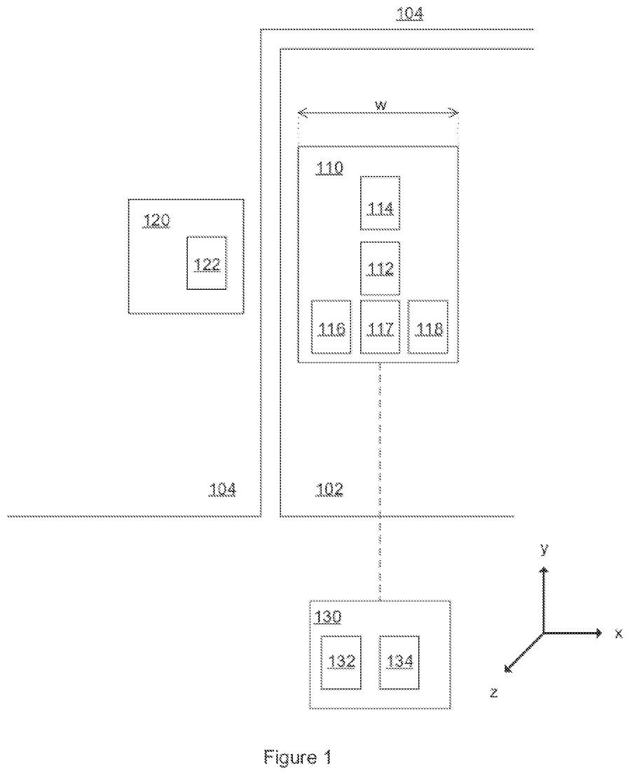

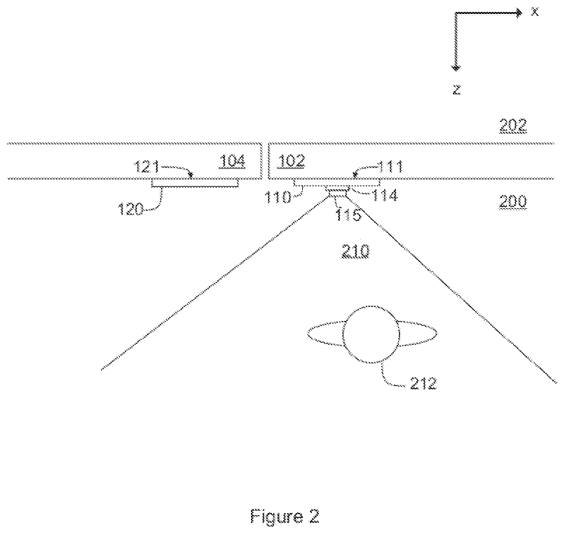

FIG. 1 and FIG. 2 are schematic illustrations of a system in accordance with an embodiment. The system is configured to monitor an access point. In the illustrated embodiment, the access point comprises a door 102 and its corresponding door frame or surround 104. In other embodiments, the access point may comprise any openable or breakable structure, for example a window or gate. The access point may further comprise any corresponding frame or surround.

FIG. 1 shows the system from a viewpoint facing the door 102. FIG. 2 shows the system from a viewpoint above the door 102.

The door 102 separates a first region 200 at an interior side of the door 102, and a second region 202 at an exterior side of the door 102. Coordinate axes are shown, with x being horizontal along a plane of the door 102 when closed, y being vertical, and z being horizontal perpendicular to the plane of the door 102 when closed.

The system comprises a first device 110 and a second device 120. The first device 110 has a surface 111 for mounting the sensor device against a first part of the access point, which in the embodiments of FIGS. 1 and 2 is the door 102. The second device 120 has a surface 121 for mounting the second device 120 against a second part of the access point. In the embodiment of FIGS. 1 and 2, the second part of the access point is the door frame 104.

In other embodiments, the first device 110 may be mounted on the door frame 104 and the second device 120 may be mounted on the door 102. In further embodiments, the first device 110 may be mounted on any first part of the access point, and the second device 120 may be mounted on any second part of the access point. Any suitable method of mounting the first device 110 and second device 120 may be used.

The first device 110 and second device 120 are shown in exaggerated size in FIGS. 1 and 2 to increase the clarity of the figures. The figures are not to scale.

The first device 110 comprises an access point sensor 112. In the embodiment of FIGS. 1 and 2, the access point sensor 112 is a magnetic sensor which is configured to sense magnetic field. The second device 120 comprises a corresponding magnet 122. The magnetic sensor 112 senses a magnetic field of the magnet. The magnetic field sensed by the magnetic sensor 112 is dependent on the separation between the access point sensor 112 and the corresponding magnet 122. A change in the position of the door 102, for example from closed to open, causes a change in the magnetic field that is sensed by the magnetic sensor 112.

The first device 110 has a width w in the plane of the door, which is parallel to the x direction when the door 102 is closed. The access point sensor 112 is positioned in the middle of the width w of the first device 110. Positioning the access point sensor 112 in the middle of the width w of the first device 110 may allow the access point sensor 112 to be used in combination with a magnet 122 that is positioned to either side of the access point sensor 112.

In other embodiments, the access point sensor 112 may be, for example, an electrical or optical contact sensor. The access point sensor 112 may be used in combination with any suitable corresponding component. For example, if the access point sensor 112 is an optical sensor, the corresponding component 122 may be a light source. The access point sensor 112 may be positioned at or near the middle of the width w of the first device 110 to allow the access point sensor 112 to be used in combination with a corresponding component on a second device 120 that is positioned at either side relative to the first device 110.

In further embodiments, the access point sensor 112 may additionally or alternatively comprise a shock sensor, for example an accelerometer, a piezoelectric sensor, or another vibration sensor. In some such embodiments, the second device 120 may be omitted.

In cases where the access point sensor 112 is used to detect an open/closed state of the access point, the second device 120 may in some embodiments be omitted. This may be the case, for example, where the access point sensor 112 detects whether a door moves to open or closed based on movement detected by an accelerometer.

In further embodiments, the access point sensor 112 may be mounted at any suitable position on the first device 110. The first device 110 may be mounted at any suitable position on the access point. In alternative embodiments, the access point sensor 112 may not form part of the first device 110. For example, the access point sensor 112 may be connected wirelessly to the first device 110.

The first device 110 further comprises an environment sensor 114. The environment sensor 114 is configured to sense the motion and/or presence of a person at or near a side of the door 102 that faces an interior of the premises. In the present embodiment, the environment sensor 114 is a passive infrared (PIR) sensor that detects differential infrared signals to detect motion. In other embodiments, the environment sensor 114 may detect presence by detecting infrared signals. In further embodiments, the environment sensor may detect presence and/or motion using any suitable method, for example by detecting one or more light beams that could be broken by a person. The environment sensor 114 and/or the processing of its output may be configured to distinguish between the present and/or motion of a human and the presence and/or motion of an animal, for example a pet, using known techniques.

The environment sensor 114 comprises a lens 115 which is located on an opposite side of the first device to the surface 111 with which the first device 110 is mounted on the door 102.

FIG. 2 shows a field of view 210 of the lens 115 of the environment sensor 114. The field of view is associated with the first region 200, which in this embodiment is interior to the access point. In FIG. 2, a person 212 is present within the field of view 210.

In the embodiment of FIGS. 1 and 2, the environment sensor 114 is positioned in the middle of the width w of the first device 110 with its field of view being symmetric in the horizontal plane, with respect to a normal vector from the surface 111. Positioning the environment sensor 114 in the middle of the width w of the first device 110 may allow the environment sensor 114 to be used when the device 110 is mounted to either side of an access point while maintaining the same functionality and appearance in both cases. For example, depending on a configuration of a door, the device 110 may be mounted on the left side of the door, or on the right side of the door.

In further embodiments, the environment sensor 114 may be mounted at any suitable position on the first device 110. In alternative embodiments, the environment sensor 114 may not form part of the first device 110. For example, the environment sensor 114 may be connected wirelessly to the first device 110.

The first device 110 further comprises processing circuitry 116 which is configured to receive and process signals from the access point sensor 112 and environment sensor 114. The first device 110 further comprises a memory 117.

The first device 110 further comprises a wireless transceiver 118 configured to transmit signals to, and receive signals from, a control hub 130. In other embodiments, the first device 110 may comprise any suitable transmitter and/or receiver for transmitting signals to and/or receiving signals from the control hub 130.

In the embodiment of FIGS. 1 and 2, the system also includes the control hub 130.

In the embodiment of FIGS. 1 and 2, the access point sensor 112, environment sensor 114, processing circuitry 116, and wireless transceiver 118 are housed within a common housing. The common housing also houses the memory 117. The common housing also has a battery interface for holding and receiving power from one or more batteries, so that no connection to mains power is needed. In other embodiments, any suitable combination of components may be housed within a common housing.

The control hub 130 comprises processing circuitry 132 and a wireless transceiver 134 configured to transmit signals to, and receive signals from, the first device 110. In some embodiments, the wireless transceiver 134 is also configured to transmit signals to and/or receive signals from further sensor devices. In other embodiments, any suitable transmitter and/or receiver may be configured to transmit signals to, and receive signals from, the first device 110.

The processing circuitry 132 of the control hub 130, and the processing circuitry 116 may each comprise one or more processing chips and/or components. For example, each processing circuitry 116, 132 may comprise: control circuitry; and/or processor circuitry; and/or at least one application specific integrated circuit (ASIC); and/or at least one field programmable gate array (FPGA); and/or single or multi-processor architectures; and/or sequential/parallel architectures; and/or at least one programmable logic controllers (PLCs); and/or at least one microprocessor; and/or at least one microcontroller; and/or a central processing unit (CPU); and/or a graphics processing unit (GPU).

In the illustrated examples, transceivers are shown as being distinct from corresponding processor circuitry 116, 132, but in some embodiments at least part of the processing aspects of the transceiver may have hardware in common with at least one processor component of the corresponding processing circuitry 116, 132.

A memory may be separate from each processing circuitry 116, 132 and/or partly or wholly integrated onto a common chip(s) with the processing circuitry 116 and/or 132. The memory may store code that, when read by the processing circuitry, causes performance of any of the methods described herein, and/or as illustrated in in the drawings. For example, the memory may comprise: volatile memory, for example, one or more dynamic random access (DRAM) modules and/or static random access memory (SRAM) modules; and/or non-volatile memory, for example, one or more read only memory (ROM) modules, which for example may comprise a Flash memory and/or other electrically erasable programmable read-only memory (EEPROM) device. The code may for example be software, firmware, or hardware description language (HDL) or may be any combination of these or any other form of code for one or more processors that is known by a person skilled in the art.

Further, in other embodiments, the memory component of the device may instead or at least in part be provided by a memory device(s) that may in some embodiments be separate or removable from the device. Such devices may comprise magnetic storage devices (e.g., hard disk, floppy disk, magnetic strips), optical disks (e.g., compact disk (CD), digital versatile disk (DVD)), smart cards, and removable flash memory devices (e.g., card, stick, key drive). Further the memory components may be distributed. For example a distributed server may store code which may be downloaded to the device for execution by the processing circuitry described herein, to perform any method described herein that is executable by the processing circuitry. In some embodiments the downloaded code may be stored on local memory of the device before execution by the processing circuitry.

In further embodiments, the system may further comprise a server (not shown) and/or a monitoring system (not shown) that are remote from the control hub 130. The control hub 130 may be configured to communicate wirelessly with the server and/or monitoring system. For example, the monitoring system may comprise a monitoring system that is used to monitor multiple premises. The monitoring system may further comprise a smartphone or other personal portable device, such as may be in the possession of an owner of the premises.

In use, the access point sensor 112 senses a magnetic field and outputs an electrical signal that is representative of the magnetic field. The processing circuitry 116 processes the electrical signal to determine if an access point event has occurred. For example, the processing circuitry 116 may determine that an access point event has occurred if the magnetic field changes in a predetermined manner over a predetermined time period. The access point event may comprise an opening of the door 102 or a closing of the door 102. In further embodiments, the access point event may comprise a shock event which is sensed by a shock sensor. Any suitable method of determining the occurrence of an access point event may be used by the processing circuitry 116.

The environment sensor 114 senses infrared light within its field of view 210 and outputs an electrical signal that is representative of the infrared light. The processing circuitry 116 processes the electrical signal to determine if an interior event has occurred. The interior event may comprise motion of a person within the field of view 210. The interior event may comprise presence of a person within the field of view 210. The processing circuitry 116 may determine that an interior event has occurred if a parameter infrared light changes in a predetermined manner over a predetermined time period. Any suitable method of determining the occurrence of an interior event may be used by the processing circuitry 116.

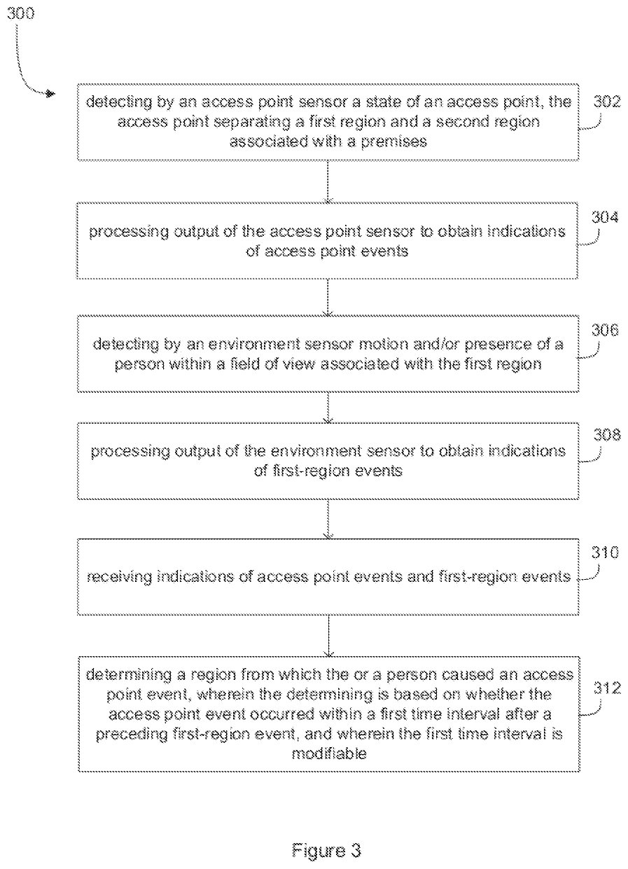

FIG. 3 is a flow chart 300 illustrating in overview a method of an embodiment.

At stage 302, the access point sensor 112 detects a state of an access point, the access point separating a first region and a second region associated with a premises.

At stage 304, the processing circuitry 116 processes output of the access point sensor to obtain indications of access point events. The processing may be performed by a part of the processing circuitry 116 that is situated within or co-located with the access point sensor 112.

At stage 306, the environment sensor 114 detects motion and/or presence of a person within a field of view associated with the first region.

At stage 308, the processing circuitry 116 processes output of the environment sensor to obtain indications of first-region events. The processing may be performed by a part of the processing circuitry 116 that is situated within or co-located with the environment sensor 112.

At stage 310, the processing circuitry 116 receives the indications of access point events and first-region events. For example, the indications may be generated by at least one first part of the processing circuitry 116 of the first device 110, and received by a second part of the processing circuitry 116 of the first device 120.

At stage 312, the processing circuitry 116 determines a region from which the or a person caused an access point event, wherein the determining is based on whether the access point event occurred within a first time interval after a preceding first-region event, and wherein the first time interval is modifiable. For example, if the access point occurred within the first time interval after the preceding first-region event, the processing circuitry may determine that the access point event was caused from the first region. If the access point did not occur within the first time interval after the preceding first-region event, the processing circuitry may determine that the access point event was caused from the second region.

In other embodiments as described below, the receiving of the indications and or the determining of the region may be performed by processing circuitry 132 of the control hub. In further embodiments, each step of the method of FIG. 3 may be performed by any suitable processing circuitry.

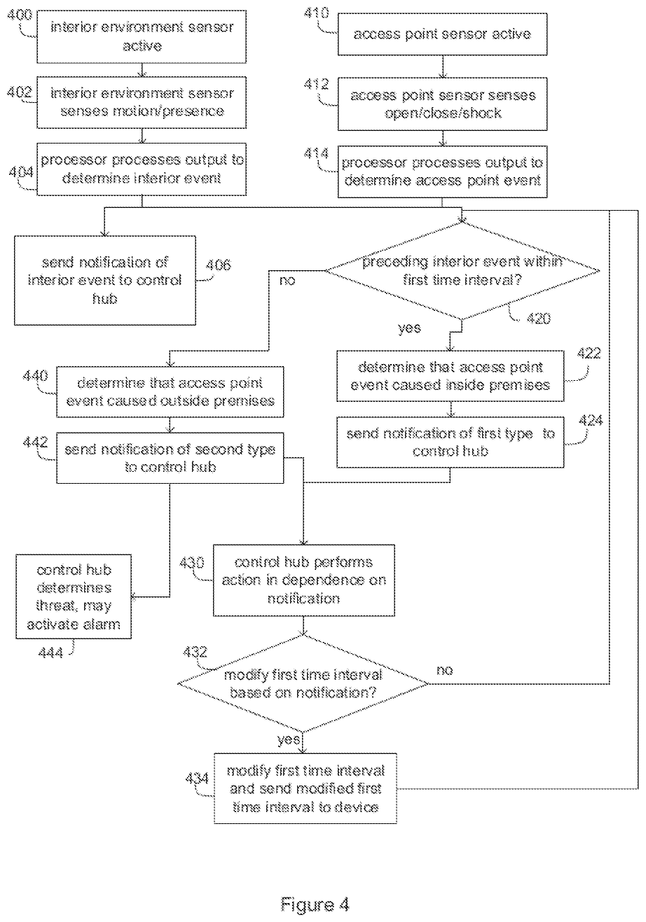

Methods for modifying the first time interval are described below with reference to FIG. 4.

FIG. 4 is a flow chart illustrating in further detail a method as described above with reference to FIG. 3. In the embodiment of FIG. 4, the first region is an interior region 200 and the second region is an exterior region 202. First-region events may therefore be referred to as interior events.

At stage 400, the environment sensor 114 is active. At stage 402, the environment sensor senses the motion or presence of a person. The environment sensor 114 outputs an electrical signal. At stage 404, the processing circuitry 116 processes the output of the environment sensor 114 and determines that an interior event has occurred. The processing circuitry 116 stores an indication of the interior event in memory 117. In the present embodiment, the stored indication comprises a time of the interior event, for example as a timestamp.

In the present embodiment, the processing circuitry 116 is configured to send notifications of interior events to the control hub 130 as the interior events occur. The notifications are sent independently of whether the interior events are associated with subsequent access point events. At stage 406, the processing circuitry 116 instructs the wireless transceiver 118 to transmit a notification of the interior event to the control hub 130. The notification comprises an indication that the interior event has occurred. The notification may also comprise a time at which the interior event occurred. In other embodiments, stage 406 is omitted from the method of FIG. 4.

Stages 400 to 406 may be repeated multiple times to determine multiple interior events. The control hub 130 may be configured to perform an action in response to receiving notification of one or more interior events, for example an arming or disarming action (not shown in FIG. 4). Such actions are described in further detail below.

At stage 410, the access point sensor 112 is active. At stage 412, the access point sensor 112 senses motion of the access point, for example an opening of the access point. The access point sensor 112 outputs an electrical signal. The processing circuitry 116 processes the electrical signal output by the access point sensor 112 and determines that an access point event has occurred. The processing circuitry 116 stores an indication of the access point event in the memory 117. In the present embodiments, the stored indication comprises a time of the interior event, for example as a timestamp.

Stages 410 to 414 may be repeated multiple times to determine multiple access point events. For each access point event, the flow chart proceeds to stage 420.

At stage 420, the processing circuitry 116 receives an indication of an access point event, for example by retrieving the indication from memory 117. The processing circuitry 116 receives an indication of an interior event that preceded the access point event. If multiple interior events preceded the access point event, the processing circuitry 116 uses the interior event that was closest in time to the access point event.

The processing circuitry 116 receives a first time interval from the memory 117. For example, the first time interval may be 30 seconds.

The processing circuitry 116 determines whether the preceding interior event occurred within the first time interval before the access point event.

If the preceding interior event occurred within the first time interval before the access point event, the flow chart proceeds to stage 422. At stage 422, the processing circuitry 116 determines that a person inside the premises caused the access point event.

The determination performed by the processing circuitry 116 assumes that if an interior event occurs shortly before an access point event, the person detected in the interior event is the person who caused the access point event. For example, an occupant of the premises may approach a door from the inside in order to open the door.

At stage 424, the processing circuitry 116 instructs the wireless transceiver 118 to transmit a notification of a first type. The notification indicates that an access point event has occurred that has been caused by an action inside the premises. The notification may also include a time associated with the access point event and/or a time associated with the interior event. The notification may include a time difference between the interior event and the access point event. The wireless transceiver 118 transmits the notification wirelessly to the control hub 130. The notification is received by the wireless transceiver 134 of the control hub 130.

At stage 430, the processing circuitry 132 of the control hub 130 determines and instructs an action to be taken in response to the notification of the first type. For example, the processing circuitry may instruct a disarming of the system. If the system is armed at the time that the notification of the first type is received, the processing circuitry 132 may instruct that no alert or alarm should be raised despite the system being armed.

In some circumstances, the system may be unarmed at the time that the notification of the first type is received. If a person tries to arm the system before the control hub 130 has received a notification that the access point has been closed, the control hub 130 may prevent the arming of the system. The action in response to the notification of the first type may comprise notifying the person that the door is open, for example by issuing an audio cue via a speaker.

In some circumstances, no action may be instructed.

At stage 432, the processing circuitry 132 of the control hub 130 determines whether the first time interval is to be modified based on the notification of the first type. Modification of the first time interval is described in detail below. In other embodiments, stages 430 and 432 may be performed in either order, or simultaneously.

If the processing circuitry 132 determines that the first time interval is to be modified, the flow chart proceeds to stage 434. The processing circuitry 132 modifies the first time interval in accordance with any appropriate modification method. Some modification methods are described below. The processing circuitry 132 instructs the wireless transceiver 132 of the control hub 130 to transmit a modified first time interval to the first device 110. The modified first time interval is stored in the memory 117. The modified first time interval is used in a next instance of stage 420 for a further access point event.

If the processing circuitry 132 determines that the first time interval is not to be modified, the flow chart proceeds to a next instance of stage 420 using the current value for the first time interval.

The case in which the processing circuitry 116 determines at stage 420 that the preceding interior event did not occur within the first time interval is now described. In some circumstances, a time difference between the access point event and the preceding interior event may be greater than the first time interval. In some circumstances, there may be no preceding interior event at all. At least, it may be considered that there is effectively no preceding interior event. This may occur for example if an elapsed time after a preceding event is so large as to be irrelevant (e.g. surely uncorrelated) and therefore no longer recorded

At stage 420, the processing circuitry 116 determines that the preceding interior event did not occur within the first time interval. The flow chart proceeds to stage 440. At stage 440, the processing circuitry 116 determines that the access point event was caused by an event outside the premises.

The determination performed by the processing circuitry 116 assumes that if the time between an interior event and a following access point event is longer than the first time interval, the person detected in the interior event is not the person who caused the access point event. It is assumed instead that the access point event was caused from outside the premises. In some circumstances, the access point event may have been caused by an intruder. For example, an intruder may have opened the door when not authorised to do so. In embodiments in which the access point sensor comprises a shock sensor, the access point event may be a vibration event which may be caused by an attempted entry.

At stage 442, the processing circuitry 116 instructs the wireless transceiver 118 to transmit a notification of a second type. The notification of the second type indicates that an access point event has occurred that has been caused by an action outside the premises. The notification may also include a time associated with the access point event and/or a time associated with the interior event. The notification may include a time difference between the interior event and the access point event. The wireless transceiver 118 transmits the notification of the second type wirelessly to the control hub 130. The notification of the second type is received by the wireless transceiver 134 of the control hub 130.

At stage 444, the processing circuitry 132 of the control hub 130 processes the received notification of the second type and determines that a threat may be present. In the present embodiment, the control hub 130 has an armed state and an unarmed state. The processing circuitry 132 of the control hub 130 may be configured to identify a threat based on the receipt of a notification of the second type that an event has occurred that was caused by an action from outside the environment. In the embodiment of FIG. 4, the processing circuitry 132 of the control hub 130 may be configured to identify the threat even when the control hub 130 is in the unarmed state. In other embodiments, the processing of the notification may differ in dependence on whether the control hub 130 is armed or unarmed.

The processing circuitry 132 determines whether to activate an alarm. For example, the processing circuitry 132 may determine whether to activate an alarm based on an alarmed or disarmed state of the system. The processing circuitry 132 may determine whether to activate an alarm based on information about whether occupants of the house are present. This can be based on information other than whether there is an access point event. For example, it may be based on detected motion that is irrespective of the door state

In the present embodiment, the processing circuitry 132 may activate an alarm (not shown in FIGS. 1 and 2) which is configured to operate acoustic and/or visual transducers to issue an audible or visible alarm signal. The alarm may form part of the control hub 130. In embodiments in which the alarm is not part of the control hub 130, the processing circuitry 132 may instruct the wireless transceiver 134 of the control hub to transmit instructions to activate the alarm. In addition (or in some embodiments instead of) activating an alarm, the processing circuitry may instruct a transmitter to send an alert notification to remote monitoring system and/or server.

The flow chart proceeds to stage 430. At stage 430, the processing circuitry 132 of the control hub 130 determines and instructs an action to be taken in response to the notification of the second type. For example, the processing circuitry 132 may instruct an alarm. The processing circuitry may instruct an arming of the system. In some circumstances, no action may be instructed.

At stage 432, the processing circuitry 132 of the control hub 130 determines whether the first time interval is to be modified based on the notification of the second type. Modification of the first time interval is described in detail below.

If the processing circuitry 132 determines that the first time interval is to be modified, the flow chart proceeds to stage 434. The processing circuitry 132 instructs the wireless transceiver 132 of the control hub 130 to transmit a modified first time interval to the first device 110. The modified first time interval is stored in the memory 117. The modified first time interval is used in a next instance of stage 420 for a further access point event.

If the processing circuitry 132 determines that the first time interval is not to be modified, the flow chart proceeds to a next instance of stage 420 using the current value for the first time interval.

The method of FIG. 4 may be used to detect from which side an action affecting an access point has happened using a motion/presence detector in combination with a sensor for detecting a state of the access point, for example an open/closed state or a shock at the access point. In the embodiment of FIG. 4, the motion/presence detector is a PIR sensor and the access point sensor is a magnetic sensor to detect an open/closed state. In alternative embodiments, the access point sensor may alternatively or additionally be a shock sensor. The device may be mounted at the access point, for example on a static frame of the access point if the access point is openable. The motion/presence detector faces an environment of interest to which the access point provides access. For example, the environment of interest may be an area of restricted and/or secured access (at least temporarily) and/or an area in which activity or one or more residents is monitored, e.g. for their wellbeing. The environment of interest in the embodiment of FIG. 4 is inside the house.

If a person does something to affect the access point from the inside of the environment, they will approach the access point from the inside of the environment, which means that they will be sensed by the motion/presence detector before an opening or shock happens and is sensed. By contrast, if the action happens from the outside of the environment, the access point sensor will detect the action first if there is no detected (e.g. moving) object on the inside, for example no resident on the inside. There might be no presence/motion detection after the access point event. Alternatively, the detection of a presence/motion event will be after the opening or shock event.

A fault may be generated when an access point is opened unless motion is detected inside the environment within the first time interval before the opening event.

By determining a direction from which an access point event is caused, at least some false alarms may be avoided. The control hub is notified of access point events that are caused from the inside as well as access point events that are caused from the outside. Notifying the control hub of access point events that are caused from the outside may allow security actions to be performed, for example if it is suspected that an intruder is trying to enter the premises or has entered the premises. Notifying the control hub of access point events that are caused from the inside may provide the control hub with information about the state of the access point. For example, the control hub may be informed that opening of a door has occurred, and may determine that a current state of the door is open. If a person then tries to arm the alarm, the person can be given a notification that a door is open. Notifying the control hub of access point events that are caused from the inside may further provide the control hub with information about activity of an occupant of the premises.

In the embodiment of FIG. 4, the first region 200 is an interior region and the second region 202 is an exterior region. In other embodiments, the first region may be an exterior region and first-region events may be exterior events. The second region may be an interior region. The processing circuitry 116 may be configured to determine that an event is an exterior event if it occurs within the first time interval. In further embodiments, the first region and second region may be different interior regions which are separated by the access point. In other embodiments, the first region and second region may be different exterior regions which are separated by the access point.

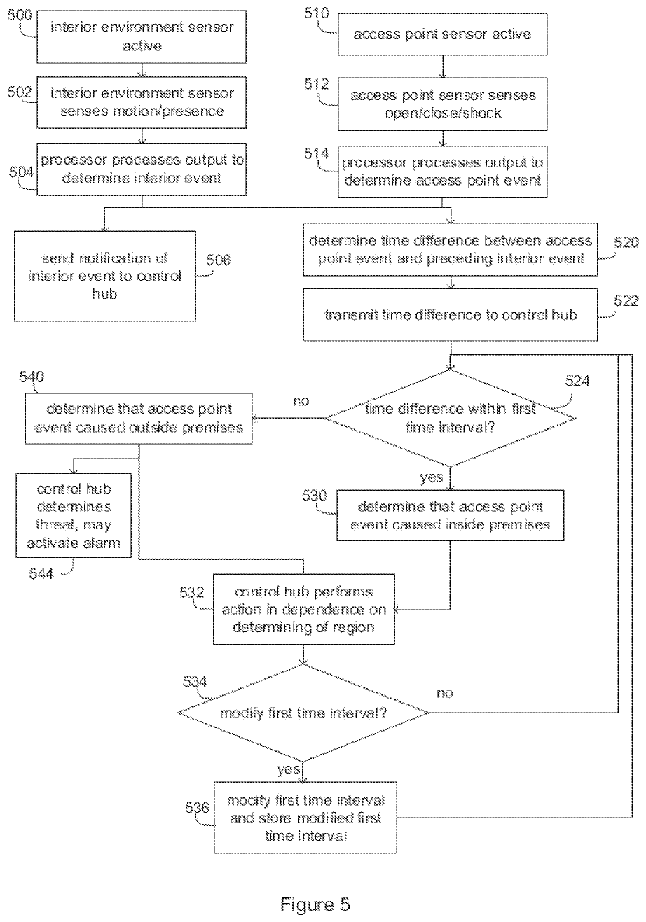

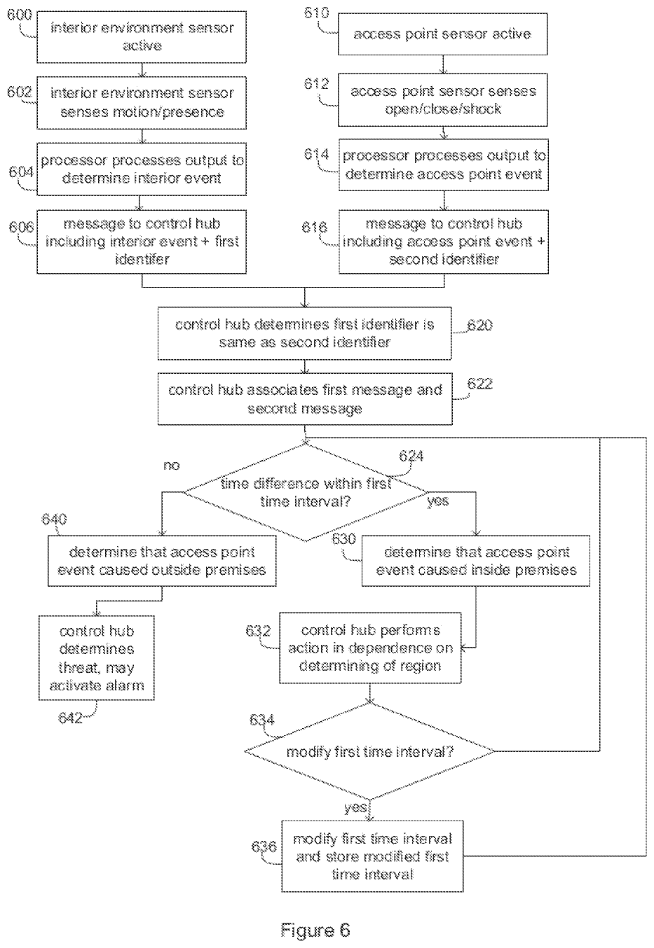

In the embodiment of FIG. 4, some steps are performed by the processing circuitry 116 and other steps are performed by the processing circuitry 132 of the control hub 130. In other embodiments, any of the steps may be performed by any suitable processing circuitry, which may be located anywhere within the system. FIGS. 5 and 6, as described below, illustrate embodiments in which the determination of the region from which the access point was caused is performed in the control hub 130 rather than in the first device 110.

In some embodiments, the determining of whether to modify the first time interval is performed by the processing circuitry 116 of the first device 110 instead of, or in addition to, the processing circuitry 132 of the control hub 130. In further embodiments, the first time interval is not modifiable.

An initial value for the first time interval may be selected based on characteristics of the access point. For example, a different first time interval may be used for a door than for a window. A different first time interval may be used for an access point that is heavy and/or difficult to open than one that is light and/or easy to open.

The first time interval may be selected based on a characteristic of a resident of the premises, for example a resident's age or mobility. A longer first time interval may be used for an elderly and/or low mobility person than would be used for the general population.

Typically, a PIR may detect movement events only every few seconds, for example every 5 seconds. A person on the inside of a door or window may spend, for example, 20 seconds at the door or window before accessing the door of window. Therefore, a typical initial setting for the first time interval may be, for example, 30 seconds.

The longer the first time interval, the less secure the system may be, because identification of an external opening event may be made less reliable. However, for older people it may be appropriate to lengthen the first time interval anyway. An older person may take, for example 40 seconds at a door before opening it. In some circumstances, the environment sensor may detect their movement to arrive at the door but may not detect their movement at the door itself.

In some embodiments, different first time intervals may be used in different arming stated. For example, a longer first time interval may be used when the premises is unarmed, since it is known that a person is home. A shorter first time interval may be used when the premises is armed, since it is considered to be very unlikely that a person will open an access point from the inside when the system is armed.

As described above, at stage 423 the processing circuitry 132 determines whether to modify the first time interval in response to a notification of a first type, or in response to a notification of a second type.

In some embodiments, the processing circuitry 132 decides to increase the first time interval based on a time difference between the access point event and the preceding interior event.

In one embodiment, the first time interval is initially set at 30 seconds. The processing circuitry 132 receives a notification of the second type. The notification includes a time difference. The time difference is greater than the first time interval of 30 seconds but is less than a second time interval, for example 60 seconds.

Although the event has been determined to be caused from the second, exterior region 202, it may be the case that the event was caused from the first, interior region 200 by a resident who is older and taking longer to open the access point.

If the time difference is greater than the first time interval but less than the second time interval, the processing circuitry 132 increases the first time interval to be applied to subsequent events.

In this embodiment, the processing circuitry 132 changes the first time interval by an increment of 5 seconds at a time. For example, even if the time difference of the event is 58 seconds, the first time interval is only increased to 35 seconds initially. In other embodiments, a different increment may be used.

Changing an increment gradually may prevent an intruder from being able to modify the threshold quickly by repeated actions. In some embodiments, a time delay between increases of the first time interval is applied. For example, the first time interval may only be changed once an hour or once a day. In some embodiments, a further modification may be made only if a time greater than a predetermined delay window has elapsed between the preceding modification of the first time interval and the proposed further modification of the first time interval. In some embodiments, a further modification may be made only if a time greater than the predetermined delay window has elapsed between an event that triggered the preceding modification of the first time interval and an event that triggered the proposed further modification of the first time interval. In further embodiments, a time between any suitable events, measurements or instructions may be compared to the predetermined delay window to determine whether a further modification may be made. In some embodiments, a length of the delay window may be modified, for example in dependence on preceding events and/or preceding changes to the first time interval.

In some embodiments, the first time interval may be changed only after a set number of measurements have been taken by the sensors. In some embodiments, the first time interval may be changed only after a set number of events.

In this embodiment, the processing circuitry 132 changes the first time interval based on a single event having a time difference that is greater than the first time interval but less than the second time interval. In other embodiments, the processing circuitry 132 may consider time differences for a plurality of access points events and corresponding interior events. For example, the processing circuitry 132 may consider the 5 most recent access point events, or the 10 most recent access point events.

For example, the processing circuitry 132 may determine a minimum, maximum, mean or other value for time differences of a preceding number of events, for example 5 or 10 events. The processing circuitry 132 may modify the first time interval based on the determined minimum, maximum, mean or other value. For example, the processing circuitry 132 may increase the first time interval if a mean time difference for the preceding 5 access point events is above the first time interval but below the second time interval.

The processing circuitry 132 may apply an upper bound to the first time interval. For example, the first processing circuitry 132 may not make any increase that would result in a first time interval of less than 60 seconds.

The processing circuitry 132 may decrease the first time interval based on a time difference for at least one preceding access point event. For example, if the first time interval is 30 seconds, the processing circuitry 132 may receive a notification of a first type for which the time difference is 15 seconds. In most embodiments, the processing circuitry 132 does not decrease the first time interval based on a single event. In one embodiment, the processing circuitry 132 determines a mean of the time differences for the last 10 events that were determined to be caused from the interior of the premises. If the mean is below 30 seconds, the processing circuitry 132 decreases the first time interval by an increment, for example by 2 seconds. In other embodiments, the processing circuitry 132 may use a maximum, mean or other value.

In some embodiments, a time delay between increases of the first time interval is applied. For example, the first time interval may only be changed once an hour or once a day. In some embodiments, the first time interval may be changed only after a set number of measurements or events. A delay window may be applied between modifications of the first time interval as described above.

A lower bound may be applied to the first time interval. For example, the processing circuitry 132 may not make a decrease that would result in the first time interval being less than 20 seconds. In some embodiments, the lower bound may be set with reference to a mean value. For example, the processing circuitry 132 may not make a decrease that would result in the first time interval being less than 10 seconds above the mean time difference for a plurality of preceding events that were determined to be caused at the interior.

In some embodiments, the lower bound may be set with reference to a maximum value for time difference for events that are determined to be caused at the interior. For example, the processing circuitry 132 may not make a decrease that would result in the first time interval being less than 2 seconds above the maximum time difference for a plurality of preceding events that were determined to be caused at the interior.

As described above, in some embodiments increasing of the first time interval may be based on only one or two events, while decreasing of the first time interval may be based on a larger number of events.

In some embodiments, the modifying of the first time interval is based on whether a false alarm has occurred. In some circumstances, a false alarm may occur. A false alarm may be an event in which the access point event was determined to be caused from the outside of the access point, but was actually caused from the inside of the access point. For example, a door may have been opened from the inside by a resident who took longer than the first time interval to open the door. In such circumstances, an alarm may be triggered but then cancelled by the resident, for example by the resident typing in an alarm code. If the resident types in the alarm code within a predetermined time, for example 2 minutes, the control hub 130 determines that the alarm was a false alarm. The control hub 130 may reclassify the access point event as having been caused from the inside.

In other embodiments, any suitable method may be used to determine that a false alarm has occurred.

The processing circuitry 132 modifies the first time interval based on the false alarm. For example, the processing circuitry 132 may increase the first time interval by an increment in response to the false alarm.

In some embodiments, the processing circuitry 132 may treat false alarm events differently from events that do not cause an alarm. In some embodiments, the modifying of the first time interval by the processing circuitry 132 based on an event may depend on whether the control hub 130 was in an armed state or an unarmed state at the time of the event. In some embodiments, a different first time interval is used when the control hub 130 is in an armed state than when the control hub 130 is in an unarmed state.

In some embodiments, the first time interval is modified based on a time of day. For example, a first value or values for the first time interval may be used during the day, and a second value or values for the first time interval may be used at night.

The use of a modifiable first time interval may allow a monitoring system to be tailored to individual conditions of an access point. In some circumstances, the individual conditions of an access point may not be fully known on installation. For example, an installer may not know how and when the access point is typically opened. The installer may not know the characteristics of one or more users of the access point. Modifying the first time interval over time may allow security to be balanced with the risk of false alarms. In some circumstances, modifying the first time interval may reduce a number of false alarms. Performing the modifying automatically may allow the first time interval to be tailored to a specific access point without requiring input from a user or installer. Further, the tailoring may be adaptively learned.

In the embodiment of FIG. 4, the determining of a region from which an access point event was caused is performed by the processing circuitry 116 of the first device 110. A notification of a first or second type is transmitted to the control hub 130.

FIG. 5 is a flow chart illustrating in overview an embodiment in which the processing circuitry 116 of the first device 110 determines a time difference between the access point event and the preceding interior event. The time difference is transmitted to the control hub 130, and the processing circuitry 132 of the control hub 130 performs the determining of the region from which the access point event was caused.

Stages 500 to 506 are the same as stages 400 to 406 respectively of FIG. 4. Stages 510 to 514 are the same as stages 410 to 414 respectively of FIG. 4.

At stage 520 of FIG. 5, the processing circuitry 116 of the first device 110 determines a time difference between an access point event and a preceding interior event. In the embodiment of FIG. 5, the processing circuitry 116 does not perform a determination of a region from which the access point is caused.

At stage 522, the processing circuitry 116 instructs the wireless transceiver 118 to transmit a message comprising the determined time difference. The message may also comprise a time of the access point event and/or a time of the interior event. The wireless transceiver 134 of the control hub 130 receives the message comprising the determined time difference.

In other embodiments, the processing circuitry 116 instructs transmission of the time difference only if the time difference falls within a predetermined time window. For example, the predetermined time window may be one minute or two minutes. The predetermined time window may be significantly longer than an expected time difference for an access point event that is caused from an interior region. In some embodiments, the time window is modifiable. The time window may be modified using a modification method as described above with respect to the modification of the first time interval. The time window may be increased or decreased. The time window may be modified in dependence on time differences between previous interior events and access point events.

At stage 524, the processing circuitry 132 of the control hub 130 receives the first time interval. For example, the first time interval may be stored locally in a memory of the control hub (not shown in FIGS. 1 and 2).

The processing circuitry 132 compares the determined time difference to the first time interval. If the determined time difference is less than the first time interval, the flow chart proceeds to stage 530. At stage 530, the processing circuitry 132 determines that the access point event was caused from the interior of the premises. At stage 532, the processing circuitry 132 instructs an action based on the determination. The action may be any appropriate action, for example any of the actions described above with reference to stage 430 of FIG. 4.

At stage 534, the processing circuitry 132 determines whether to modify the first time interval based on the determination that the access point event was caused from the interior of the premises. Stages 532 and 534 may be performed in either order, or simultaneously. The determination of whether to modify the first time interval may be based on any appropriate criteria, for example criteria as described above with reference to stage 434 of FIG. 4.

If the processing circuitry 132 determines that the first time interval should be modified, the processing circuitry 132 proceeds to stage 536. The processing circuitry 132 modifies the first time interval in accordance with any appropriate modification method, for example a modification method as described above. The processing circuitry 132 stores the modified first time interval in local memory (not shown). The modified first time interval is then used for a subsequent instance of stage 524.

If the processing circuitry 132 determines that the first time interval should not be modified, the current first time interval continues to be used for a subsequent instance of stage 524.

Stage 524 is now considered for the case in which the time difference is not within the first time interval. The flow chart proceeds to stage 540. At stage 540, the processing circuitry 132 of the control hub 130 determines that the access point event was caused outside the premises. The flow chart proceeds to stage 544, which is the same as stage 444 as described above.

The flow chart proceeds to stage 532. Stage 532 may occur before, after, or at the same time as stage 544. At stage 532, the processing circuitry 132 instructs an action based on the determination that the access point event was caused outside the premises. At stage 534 the processing circuitry 132 determines whether the first time interval should be modified. The flow chart then proceeds to stage 536 and/or to a further instance of stage 524, as described above.

A difference between the embodiment of FIG. 5 and the embodiment of FIG. 4 is that the comparison of the time difference to the first time interval is performed at the control hub 130 instead of at the first device 110. Rather than determine whether the event was caused by an action from the environment, the first device 110 determines a time difference between a detection of an action affecting the access point and a last motion/presence detected before the detected action. The device transmits an indication of the time difference. In some embodiments, the indication is only transmitted if it is within a predetermined time window.

The control panel then compares the time difference with the first time interval, which provides a threshold to determine whether the action was caused from inside or outside the environment.

In some circumstances, performing the comparison at the control hub 130 may provide more flexibility and/or control. Thresholding using the first time interval at the control hub 130 may be considered to be more powerful than thresholding at the first device 110, because the control hub 130 may have access to other information than that available to the first device 110. For example, the control hub 130 may modify the first time interval based on information from multiple access points.

In some circumstances, complexity may be reduced by determining, modifying and storing the first time interval at the control hub 130 without transmitting the first time interval to the first device 110 or storing the first time interval at the first device 110. By transmitting a time difference in a message, the control hub 130 does not need to calculate it. It may otherwise obtain the time difference by linking different messages and subtracting associated times, or by starting a timer every time it receives a motion detected event. This could lead to a lot of timers being run at the control hub 130 if the control hub 130 is controlling multiple environment sensors and access point sensors.

In some embodiments, the control hub 130 may apply a common first time interval to time differences from multiple access points. In other embodiments, different first time intervals may be used for different access points. The threshold may be changed depending on the location of the installation. For example, a shorter threshold may suit a large window better than a heavy door.

In the embodiment of FIG. 5, the first region 200 is an interior region and the second region 202 is an exterior region. In other embodiments, the first region may be an exterior region and the second region may be an interior region. In further embodiments, the first region and second region may be different interior regions or different exterior regions. In the embodiment of FIG. 5, some steps are performed by the processing circuitry 116 and other steps are performed by the processing circuitry 132 of the control hub 130. In other embodiments, any of the steps may be performed by any suitable processing circuitry, which may be located anywhere within the system. In some embodiments, the first time interval is not modifiable and stage 534 and 536 are deleted.

In the embodiments of FIGS. 4 and 5, indications of events based on the motion/presence sensor 114 are transmitted by the device 110 regardless of whether there is a timing correlation with the detected action at the access point. The notification of an interior event alone may be considered to be a notification of a third type. In an armed mode, the motion/presence sensor 114 may double as an intruder detector for detecting intruders in the environment event if they did not enter the premises through the access point associated with the motion/presence sensor 114. In an unarmed mode, a detected presence or motion may be used for other purposes. For example, a detected motion may treated as an indication of activity by a person (e.g. a resident) entitled to be in the environment, and in response a control hub may instruct turning on of a light in the environment.

In other embodiments, indications of access point events may be transmitted by the device 110 independently of whether the access point event has been associated with an interior event. The notification of an access point event alone may be considered to be a notification of a fourth type. The control hub 130 may use the notification of an access point event to determine a state of the access point. This may include access point closing events. It may also include access point opening events.

FIG. 6 is a flow chart illustrating in overview an embodiment in which the indications of access point events and interior events are transmitted to the control hub 130. The control hub 130 then associates access point events and interior events for the same access point using a common identifier. The control hub 130 determines whether an access point event occurred within a first time interval after a preceding interior event for the same access point.

For simplicity, the flow chart of FIG. 6 only refers to a single access point sensor and environment sensor. In practice, a system may comprise a plurality of access points, each provided with a respective access point sensor and environment sensor.

In the embodiment of FIG. 6, identifiers are assigned to the access point sensors and environment sensors. Each access point sensor has a different identifier. Each environment sensor is assigned the same identifier as the access point sensor for the access point to which the environment sensor corresponds. A common identifier is therefore used for both the access point sensor and the environment sensor corresponding to a given access point. The common identifier may be a panel identifier associated with the first device.

Stages 600 to 604 are the same as stages 400 to 406 respectively of FIG. 4. At stage 606, the processing circuitry 116 instructs the wireless transceiver 118 to transmit to the control hub 130 a first message comprising an indication of the environment event and a first identifier, which is the identifier assigned to the environment sensor. The first message may comprise a time of the environment event. The wireless transceiver 134 of the control hub 130 receives the first message.

Stages 610 to 614 are the same as stages 410 to 414 respectively of FIG. 4. At stage 616, the processing circuitry 116 instructs the wireless transceiver 118 to transmit to the control hub 130 a second message comprising an indication of the access point event and a second identifier, which is the identifier assigned to the access point sensor. The second message may comprise a time of the access point event. The wireless transceiver 134 of the control hub 130 receives the second message.

At stage 620, the processing circuitry 132 of the control hub 130 determines that the first identifier of the first message is the same as the second identifier of the second message. Although only two messages from the first device 110 are shown in the flow chart of FIG. 6, in practice the control hub 130 may receive many messages from a plurality of peripheral devices. The messages may include messages having a number of different identifiers. By determining which messages have the same identifiers, the control hub 130 may determine which messages relate to the same access point.

At stage 622, the processing circuitry 132 of the control hub 130 associates the first message and the second message based on the first and second identifiers being the same. The processing circuitry 132 thereby associates the interior event of the first message with the access point event of the second message. In some embodiments, the processing circuitry 132 only associates the interior event and the access point event if they occur within a predetermined time window.

At stage 624, the processing circuitry 132 determines whether the access point event occurred within a first time interval after the interior event. The processing circuitry 132 may use time information included in the messages. Alternatively, the processing circuitry 132 may use a time at which each message is received as a proxy for the time of the event to which the message relates. Any method of comparison to the first time interval may be used.

Stages 630 to 636 of FIG. 6 are substantially the same as stages 530 to 536 respectively of FIG. 5 as described above. Stages 640 and 642 of FIG. 6 are substantially the same as stages 640 and 642 respectively of FIG. 5 as described above.

In some embodiments, the control hub 130 may associate the events with a specific access point. For example, the control hub 130 may associate a threat and/or alarm with a specific access point of the premises, for example by using the identifier. In other embodiments, the control hub 130 may determine that a threat has occurred without locating the threat to a specific one of the access points.

Messages received from the first device 110 that include indications of access point events may be used by the control hub 130 to identify a state of the access point, for example whether the access point is opened or closed. Messages received from the first device 110 that include indications of environment events may be used by the control hub 130 to detect the presence of an intruder or to perform other actions, for example turning on a light.

In other systems, the access point sensor 112 may be assigned a different identifier from the environment sensor 114. In order to associate the messages, the control hub 130 may have to look up the identifiers, for example in a pre-programmed table of identifiers. The table of identifiers may be updated manually, which may cause errors. By instead using a common identifier for the access point sensor 112 and environment sensor 114, the control hub 130 may easily associate messages from the access point sensor 112 with messages from the environment sensor 114.

In embodiments described above, times of first-region events and access point events are recorded along with the indications of the first-region events and access point events. Times of events are compared to determine whether an access point event and a first-region event occurred within a first time interval. In other embodiments, any suitable method of determining whether the access point event and preceding first-region event occurred within the first time interval may be used. For example, a timer may be started when a first-region event occurs and stopped when a subsequent access point occurs. In some embodiments, the timer may be configured to time out after a set time. The set time may be the first time interval or another, longer time interval.

Steps are described above as being performed by specific processing circuitry, for example the processing circuitry 116 of the first device 110 and the processing circuitry 132 of the control hub 130. In other embodiments, the steps may be described by any suitable number of processors which may be located anywhere within the system. The steps may be divided across any number of processors in any suitable manner. A single step may be split across multiple processors, or multiple steps may be performed by a single processor.

Data may be sent to and from any suitable processors. For example, data described as being sent from the first device 110 to the control hub 130 may be sent from any first part or parts of the system to any second part or parts of the system, and vice versa. Data may be sent within a single device, for example from a first processor to a second processor of the same device.

Whilst the foregoing description has described exemplary embodiments, it will be understood by those skilled in the art that many variations of the embodiments can be made within the scope of the present invention as defined by the claims. Moreover, features of one or more embodiments may be mixed and matched with features of one or more other embodiments.

1. An apparatus for monitoring an access point of a premises, the access point separating a first region and a second region associated with the premises,
the apparatus comprising processing circuitry configured to receive indications of access point events and first-region events,
wherein the indications of access point events are obtained by processing output of an access point sensor configured to detect a state of the access point, and
the indications of first-region events are obtained by processing output of an environment sensor configured to detect motion and/or presence of a person within a field of view associated with the first region;
wherein the processing circuitry is further configured to:
determine a region from which the or a person caused an access point event, the region comprising one of the first region and the second region, wherein the determining is based on whether the access point event occurred within a first time interval after a preceding first-region event, and wherein the first time interval is modifiable.

2. An apparatus according to claim 1, wherein the first region is located on an interior side of the access point, the second region is located on an exterior side of the access point, and the first-region events comprise interior events.

3. The apparatus according to claim 1, wherein the processing circuitry is further configured to process instructions to modify the first time interval.

4. The apparatus according to claim 3, wherein the processing circuitry is further configured to determine a time difference between the access point event and the preceding first-region event, and wherein the instructions to modify the first time interval are dependent on the determined time difference.

5. The apparatus according to claim 3, wherein the processing circuitry is configured to determine a false alarm event and to modify the first time interval in response to the false alarm event;
and/or wherein the processing circuitry is configured to modify the first time interval in dependence on at least one of: a time of day, an armed or unarmed mode, a location or type of the access point, a characteristic of an occupant of the premises.

6. The apparatus according to claim 3, wherein the modifying of the first time interval comprises increasing or decreasing the first time interval by a predetermined increment.

7. An apparatus according to claim 1, wherein the processing circuitry is configured to determine that the access point event was caused from the first region if the access point event occurred within the first time interval after the preceding first-region event; and the processing circuitry is configured to determine that the access point event was caused from the second region if the access point did not occur within the first time interval after the preceding first-region event.

8. An apparatus according to claim 7, further comprising a transmitter, wherein at least one of a) to d):
a) the processing circuitry is further configured to instruct the transmitter to transmit a notification of a first type in response to the determining that the access point event was caused from the first region;
b) the processing circuitry is further configured to instruct the transmitter of the apparatus to transmit a notification of a second type in response to the determining that the access point event was caused from the second region;
c) the processing circuitry is further configured to instruct the transmitter of the apparatus to transmit a notification of a third type in response to each indication of a first-region event; and
d) the processing circuitry is further configured to instruct the transmitter of the apparatus to transmit a notification of a fourth type in response to each indication of an access point event.

9. The apparatus according to claim 1, wherein the processing circuitry is configured to instruct an action in response to the determining of the region from which the access point event was caused.

10. The apparatus according to claim 1, wherein the apparatus has a first part and a second part, and wherein the or a transmitter of the apparatus is configured to transmit signals from the first part of the apparatus to the second part of the apparatus.

11. The apparatus according to claim 10, wherein the transmitter comprises a wireless transmitter.

12. The apparatus according to claim 10, wherein the first part of the apparatus comprises a sensor device mounted at the access point and the second part of the apparatus comprises a control hub.

13. The apparatus according to claim 10, wherein a first part of the processing circuitry is located within the first part of the apparatus and a second part of the processing circuitry is located within the second part of the apparatus.

14. The apparatus according to claim 8, wherein a first part of the processing circuitry is located within the first part of the apparatus and a second part of the processing circuitry is located within the second part of the apparatus; and wherein the first part of the processing circuitry is configured to determine the region from which the or a person caused an access point event and to instruct the transmitter to transmit the notification of the first, second, third or fourth type to the second part of the apparatus.

15. The apparatus according to claim 13, wherein the first part of the processing circuitry is configured to determine a time difference between the access point event and the preceding first-region event and to instruct the transmitter to transmit data comprising the time difference to the second part of the apparatus; and
the determining of the region from which the person caused an access point event is performed by the second part of the processing circuitry.

16. The apparatus according to claim 13, wherein the first part of the processing circuitry is configured to:
generate the indications of access point events and interior events;
instruct the transmitter to transmit to the second part of the apparatus a first message comprising an indication of an environment event; and
instruct the transmitter to transmit to the second part of the apparatus a second message comprising an indication of an access point event;
and wherein the second part of the processing circuitry is configured to perform the receiving of the indications of access point events and interior events and the determining of the region from which the person caused an access point event; wherein the first message comprises a first identifier associated with the environment sensor, and the second message comprises a second identifier associated with the access point sensor, and wherein the second identifier is the same as the first identifier, such that there is a common identifier in the first message and the second message.

17. The apparatus according to claim 13, wherein the sensor device comprises the access point sensor and the environment sensor.

18. The apparatus according to claim 1, wherein at least one of a) to c):
a) the state of the access point comprises an open or closed state of the access point;
b) the state of the at least one part of the access point comprises a vibrational state of at least part of the access point;
c) the detecting of the state of the access point comprises detecting a parameter that changes with movement of at least one part of the access point.

19. A method for monitoring an access point of a premises, the access point separating a first region and a second region associated with the premises, the method comprising:
receiving indications of access point events and first-region events,
wherein the indications of access point events are obtained by processing output of an access point sensor configured to detect a state of the access point, and
the indications of first-region events are obtained by processing output of an environment sensor configured to detect motion and/or presence of a person within a field of view associated with the first region; and
determining a region from which the or a person caused an access point event, the region comprising one of the first region and the second region, wherein the determining is based on whether the access point event occurred within a first time interval after a preceding first-region event, and wherein the first time interval is modifiable.

20. A memory comprising instructions which, when executed by processing circuitry, cause the processing circuitry to perform the steps of:
receiving indications of access point events and first-region events,
wherein the indications of access point events are obtained by processing output of an access point sensor configured to detect a state of an access point of a premises, the access point separating a first region and a second region associated with the premises, and
the indications of first-region events are obtained by processing output of an environment sensor configured to detect motion and/or presence of a person within a field of view associated with the first region; and
determining a region from which the or a person caused an access point event, the region comprising one of the first region and the second region, wherein the determining is based on whether the access point event occurred within a first time interval after a preceding first-region event, and wherein the first time interval is modifiable.
